(19) United States
(12) Patent Application Publication
(10) Pub. No.: US 2008/0250023 A1
(43) Pub. Date: Oct. 9, 2008

(54) SYSTEM AND METHOD FOR BOOKMARKING CONTENT WITH USER FEEDBACK

(76) Inventors: Peter N. Baker, Lafayette, IN (US); Christopher A. Baker, Annapolis, MD (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/695,897

(22) Filed: Apr. 3, 2007

(51) Int. Cl. G06F 17/30; G06F 17/00

(52) U.S. Cl. 707/10; 707/100; 707/102; 707/E17.005

(57) ABSTRACT

A system and method for maintaining and accessing a database containing a number of content segments indexed by broadcast time is provided. If a user is interested in a particular content segment broadcasted from a station, he activates a portable bookmarking device which creates an entry comprising a broadcast time and a user preference indicator. In one form, the user may activate one or more buttons to indicate a positive or negative preference, while in another form a number of buttons may represent a number of categories of interest, such as varying genres. Upon coupling with a gateway, the user is presented with content selected from the database based upon the created time entries. In a further form, the system intelligently identifies the broadcast station likely associated with a bookmark and additionally may perform a correction process to ensure bookmark time accuracy. Various options exist allowing the user to interact with and obtain the selected content, including bulk download and custom streaming.

### FIELD OF THE INVENTION

The present invention generally relates to a system and method for storing and processing electronic bookmarking information. More particularly, the present invention generally relates to a system and method for accessing content based upon broadcast time information coupled with a user preference indicator.

### BACKGROUND

There have been attempts to provide database systems and portable devices for content bookmarking. Those systems have achieved very limited success, due in large part to a number of different user and back end adoption problems. In particular, the costs of maintaining the infrastructure supporting the system and continuously making massive amounts of content readily available were cost prohibitive. Additionally, the costs of storage and systems capable of storing the massive amounts of content attributable to a single content provider, more or less a number of providers, were not justifiable in light of the subscription or sales base. Therefore, the costs had to be passed along to the users in some form. Further complicating the model, the struggling concept of electronic content sales at the time, the content providers received no valuable benefit for undertaking this tremendous and ongoing cost.

By providing user preference information and/or automatic donation capabilities to a remote device for creating user bookmarks, a large new area of potential benefit to a content provider is opened up. Not only can user preference indicator information be tremendously valuable to a content provider for the purposes of advertising and program selection, but additional content can be recommended to a user as well as many other valuable features. In light of the decreasing costs of implementation and the ability to derive a wealth of information from participating users, the bookmarking of content becomes a worthwhile option to content providers 90.

Additionally, many not for profit broadcast stations have often participated in fund raising campaigns such as telethons or the like. However, limited success has been achieved when viewed from the perspective of the percentage of listeners who donate. In addition, due to the complexity and cost of these fund raising campaigns, they can only be held one or twice annually. Therefore, a need exists for a model encouraging the casual listener to donate to support a broadcast station while enjoying the content provided free of charge. Additionally, providing a method for users to place anonymous donations may further encourage support or donation frequency. By allowing a listener to donate a small amount, without much effort, a larger percentage of listeners can be turning into contributors and revenues can be efficiently raised at any time.

### SUMMARY

Various technologies and techniques are disclosed for providing content, indexed by broadcast time, to a plurality of users based upon bookmark entries comprising a broadcast time and user preference indicator stored in a remote device. In one form, the user accesses a database storing a number of content segments and associated broadcast times through a series of web pages presented to the user on a gateway such as a personal computer. By connecting a bookmark device the user is able to select a number of bookmark entries for processing. A customized display is then presented on a monitor operated by the user which presents the information associated with the identified content. In one form, the broadcast station associated with a bookmark entry is static. In another form, the system intelligently selects a likely broadcast station based upon prior user selections. A number of options are made available to the user allowing interaction with the content, such as download, streaming, and bulk download for subsequent use, such as transfer to a personal multimedia device. Additionally, the system may arrange the content based upon the user preference indicator supplied, such as ordering by interest level or by category. This allows a user to access the most desirable content first, or content of a specific genre. By automatically receiving user preference indicators associated with content from a plurality of users, valuable information is made available to content providers.

In another form, a user is prompted to make a small donation to the broadcast station, a non-profit or other organization. The user indicates a willingness to donate by creating a bookmark entry during the prompted time. Upon transmission to a server, the server identifies the bookmark entry as during a donation time as determined by the broadcast station. The user is then prompted to complete payment of the donation. In a further form, the user provides payment information prior to the transmission to the server and the donation is automatically made, or made upon the authorization of the user. In another form, a donation form may be printed by the user in addition to address information in the event a user does not wish to disclose credit card information or wishes to send a check or other instrument.

Yet other forms, embodiments, objects, advantages, benefits, features, and aspects of the present invention will become apparent from the detailed description and drawings contained herein.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein, as well as from the claims.

### BRIEF DESCRIPTION OF THE DRAWINGS

FIG. 1 is a schematic diagram showing a content bookmarking and delivery system according to one embodiment of the present system and method.

FIG. 2 is a flowchart showing one example of the steps performed in storing content segments within a database.

FIG. 3 is a perspective view of a bookmarker device according to one embodiment.

FIG. 4 is a perspective view of a bookmarker device according to a second embodiment.

FIG. 5 is a functional block diagram of the bookmarker device of one embodiment.

FIG. 6 is a logical view of one example of the bookmark information created by the bookmark device in response to user activation in one form of the present system and method.

FIG. 7 is a flowchart showing a process for bookmark creation and subsequent content retrieval according to one form of the present system.

FIG. 8a is a representative screen shot showing one form of the screen presentation available on the gateway in one form of the present invention.

FIG. 8b is a representative screen shot showing one form of the screen presentation available on the gateway when a specific content segment listing is selected in one form of the present invention.

FIG. 9 is a flowchart showing one set of steps making up one form of the process for correcting bookmark time information.

FIG. 10 is a flowchart showing the steps for intelligently associating a broadcast station for use with a bookmark entry based upon prior user selections.

FIG. 11 is a flowchart showing the steps for providing the bulk download of content associated with a number of bookmark entries in a further form.

FIG. 12 is a flowchart illustrating one example of the steps involved in prompting for and receiving a donation from a user.

### DETAILED DESCRIPTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In the increasingly digital age, the varying number of ways in which we receive content, such as video, audio, and print is becoming more and more on demand every day. Currently, a user can store in excess of 20,000 3 minute audio clips on many common MP3 players, representing well over one month of continuous content. Furthermore, storage space in the form of hard drives, CD ROMs, and DVD media has grown increasingly more affordable per megabyte. Therefore, the ability to prioritize, categorize, and otherwise manage large amounts of content is becoming increasingly important from a user perspective as storage concerns diminish. In the past, radio bookmarking systems have enabled users to record a time stamp and later correlate the timestamp to a particular song or segment of a radio broadcast. However, these radio bookmarking systems often require frequent retrieval of bookmarked content in order to efficiently manage the bookmarked segments. By allowing a user to record a personal preference indicator while listening to a content segment, many valuable operations, including sorting and ranking can be performed. In addition, the level of information and features made available to the broadcaster increased in value. It shall be appreciated that use of the term bookmark herein means an electronic entry having a timestamp reflecting a broadcast time. In a further form, a bookmark also includes a user preference indicator. The present invention is directed toward storing a user interest level along with a timestamp in a personal bookmarking device, but the present invention also serves other purposes in addition to these.

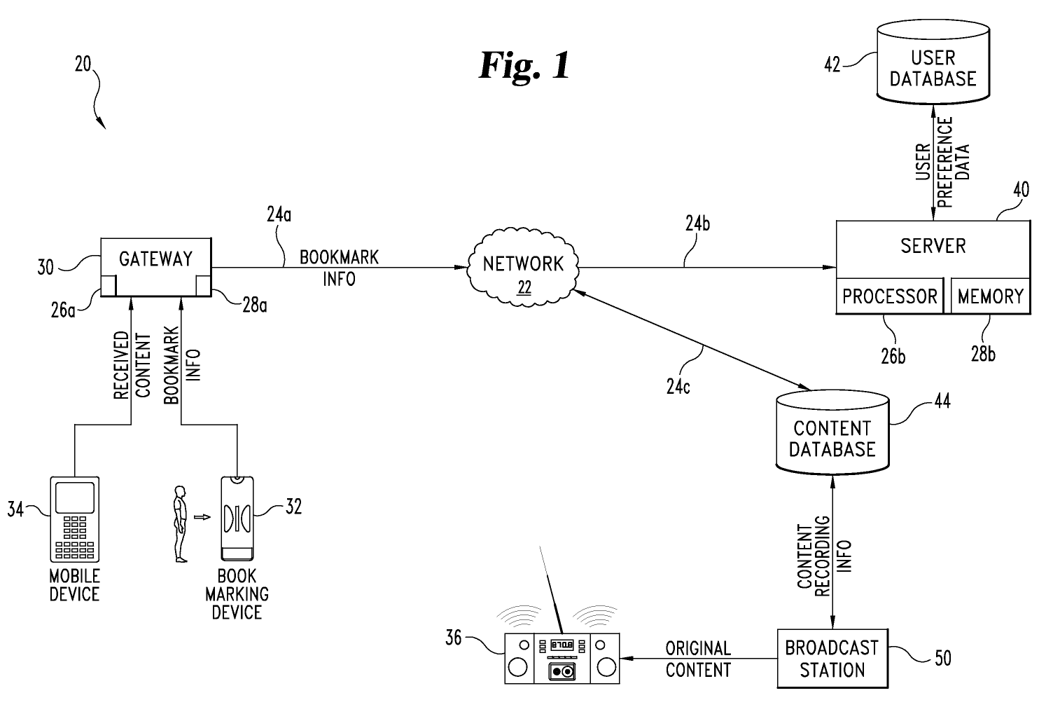

FIG. 1 shows a diagrammatic view of a content bookmarking system 20 of one embodiment of the present invention. Broadcast station 50 operates to provide content to the users of system 20, such as via the airwaves, to broadcast receiver 36. For purposes of this description, broadcast station 50 is a radio broadcast station, such as an FM or AM radio broadcast station regulated by the Federal Communications Commission (FCC). Other forms of radio broadcast may include satellite radio, internet radio, and the like. Additionally, broadcast receiver 36 may be a personal radio, stereo, car audio system, computer, or similar device.

Content database 44 operates in connection with broadcast station 50 to store and maintain recorded content segments and associated information. For example, the title, author, and the broadcast date(s) and time range(s) of a segment are provided by broadcast station 50 and stored in association with a content segment in content database 44. In one form, the content segments stored are recorded radio broadcast segments, such as talk radio programs, songs, and/or commercial advertisements, to name just a few representative examples. It shall be appreciated that the principles of the present invention may be applied to other media forms, such as broadcast television, cable, movies, or other forms of content.

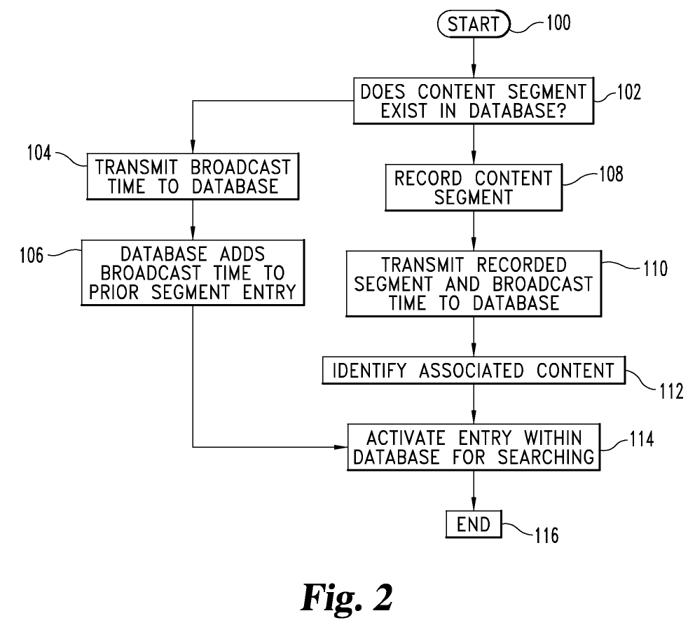

FIG. 2 illustrates, with continuing reference to FIG. 1, the steps performed by broadcast station 50 of FIG. 1 for storing content segments in content database 44 in one form of the present system and method. The process begins at start point 100 with the broadcast station 50 querying content database 44 to determine if an upcoming content segment is already store therein (stage 102). In the event of talk radio or other live content, this step may be omitted. If the content database contains the content segment, the broadcast station 50 transmits the date and time at which the broadcast of the content segment began and concluded (stage 104) to content database 44. This time information is added to the preexisting content segment entry by content database 44 (stage 106). For example, a musical piece may be broadcast hundreds of times, at different times on different broadcast stations, while only requiring storage once for purposes of efficiency. If desired, a content segment may be stored multiple times in order to include prior or post content such as a disc jockey introduction or the like.

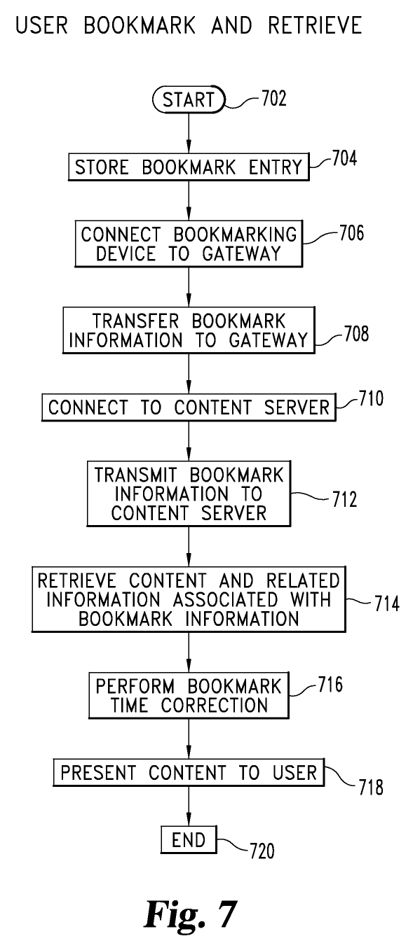

In the event a content segment is not found within content database 44, broadcast station 50 broadcasts and records a content segment (stage 108). Once the content segment is completed, the recording is transmitted to content database 44 along with time information indicating the date and time at which the broadcast of the content segment began and concluded (stage 110). Additionally, each segment includes a broadcast entity denoting the radio station upon which the content segment was broadcast, as determined by the sender. Preferably, the content segments also include other information such as the title, author, genre, album, artist, description, etc or the content segment. In one form, content segments may be transferred to content database 44 in bulk, such as hourly or daily. Preferably, the content segments are transferred to content database 44 as quickly as possibly in order to maximize their availability to the users. Once a content segment is transferred into content database 44, relations may be identified between content segments, such as those having the same author, or those of the same genre (stage 112) to facilitate quick retrieval of related content. Additionally, associated content may be added at any time thereafter, such as to ensure that current information is available. Finally, the content segments are made available within content database 44 for searching and retrieval by server 40 (114). The process ends at end point 116. It shall be appreciated that the process of FIG. 6 may be executed independently by a number of broadcast stations, such as station 50, and that content database 44 may be one large database contributed to by a number of broadcast stations or that several broadcast stations may each maintain their own content database 44 accessible to server 40.

Returning to FIG. 1, system 20 includes a gateway 30 connected to a bookmarking device 32 for receiving bookmark information stored therein by a user. Bookmark device 32, upon operation by the user, stores bookmark information, including a bookmark time for subsequent transfer to gateway 30. In a further form, bookmark device 32 also stores a user preference indicator in association with the bookmark time for purposes of reflecting information such as a user's interest level or categorization of the content currently being broadcast.

Computer network 22 couples together gateway 30, server 40, and content database 44 over network pathways 24a-24c respectively to facilitate the exchange of uploaded bookmark information received by gateway 30 from bookmarking device 32 and subsequently the corresponding content identified from content database 44 by server 40. Server 40 additionally includes user database 42 for storing individual user information including user preference information. Further, gateway 30 is connected to personal multimedia device 34 for transferring downloaded content to allow subsequent remote playback at the user's convenience.

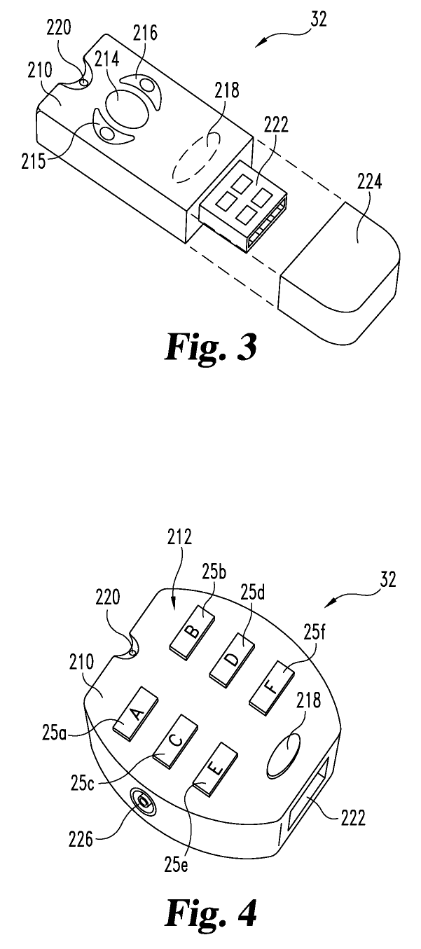

Turning to FIG. 3, a bookmark device 32 is shown in accordance with a first embodiment of the present invention. Bookmark device 32 includes an outer housing 210, which encloses a plurality of internal functional parts, described in detail hereinafter. Housing 210 preferably has a cutout 220 for allowing a user to attach the bookmark device 32 to a key ring, lanyard, or the like. Bookmark device 32 also includes a display 218, an interface connector 222 for connecting with a gateway device, and a removable cap 224 for protecting connector 222 when not in use. Preferably, display 218 may be a series of LED lights capable of indicating status with color, flashes, or the like. In a further form, the display 218 may be an LCD screen or the like. In this first embodiment, interface connector 222 is a USB connector, and bookmark device 32 also includes an input control 212 comprising a first button 214 for creating a bookmark entry, a second button 215 for indicating one of a number of positive user interest levels and a third button 216 for indicating one of a number of negative user interest levels. For example, a user might create a bookmark by activating first button 214 and associate a small positive interest level by pressing button 215 once, while the same user may alternatively indicate a strong negative interest by pressing button 216 3 times in sequence.

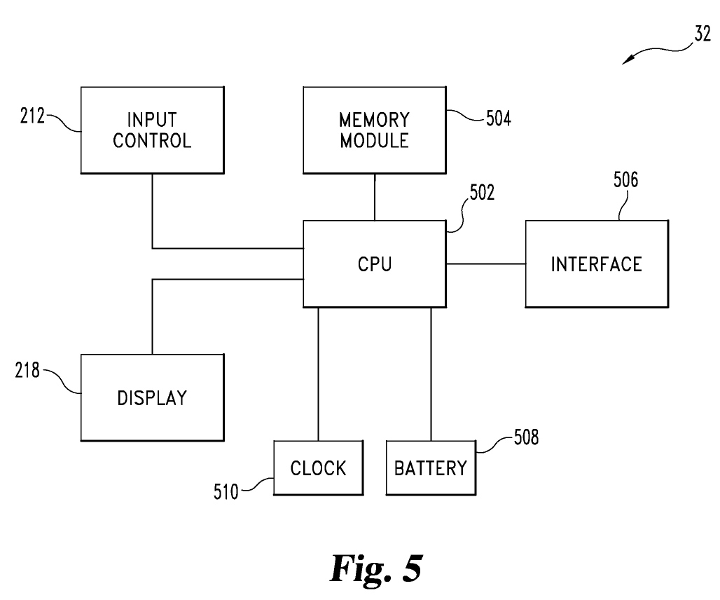

FIG. 4 shows a second embodiment of bookmark device 32. For purposes of clarity, previously described elements of bookmark device 32 will be commonly numbered and their description omitted. In this second embodiment, interface connector 222 is a wireless connector, such as infrared or Bluetooth, and input control 212 comprises a plurality of buttons 215a-f for allowing a user to indicate one of a number of user interest levels, such as categories of interest. In one form, the categories may be user defined using gateway 30 and server 40. In another form, the categories may be predetermined and indicated on their respective buttons. In a further form, each button may be activated multiple times in sequence or pressed and held for a period of time to allow the user to express an interest level. Additionally, bookmark device 32 includes charging port 226 for connection to a power source for recharging.

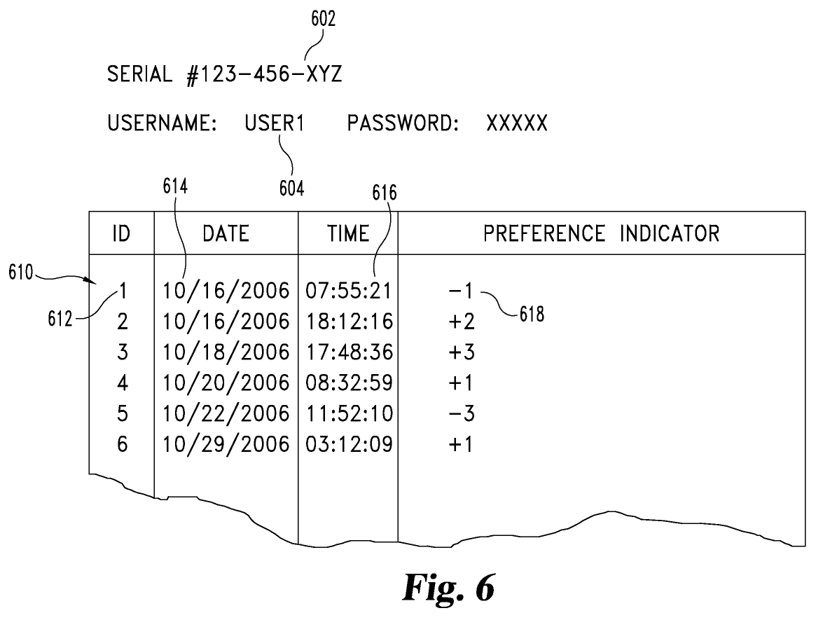

FIG. 5 shows an example of one form of the internal construction of bookmark device 32 suitable for use in the first and second embodiments. Central processing unit (CPU) 502 is connected to a memory module 504 preferably having at least 512 KB of memory storage and preferably at least 10 MB of memory storage. Preferably, memory module 504 is non-volatile to preserve bookmark information in the event of failure, removal, or power loss from battery 508. Additionally, memory module 504 may include a read only portion for storing firmware, software, or other pre-programmed information, such as software instruction for automatically presenting a web browser connection to server 40 upon connection to gateway device 30. CPU 502 is also connected to predetermined interface 506, such as USB, IEE1394, serial, Bluetooth, 802.11, or infrared to name just a few non-limiting examples. In addition, CPU 502 is connected to a battery 508, preferably rechargeable or replaceable, and clock 510 for providing accurate time information.

Turning to FIG. 6, with continued reference to FIG. 5, a logical view of an example of the bookmark information created by the bookmark device 32 of system 20 is illustrated. It shall be appreciated that memory module 504 stores the information within bookmark device 32 as described below. Bookmark device 32 stores a unique serial number 602, which is stored in the read-only portion of memory 504. Additionally, upon first use, a usemame and password combination 604 may be stored within device 32 in order to facilitate fast log in upon connection with gateway 30 and exchange with server 40. Alternatively, in order to preserve privacy and security, only a username may be stored, requiring the user to supply the corresponding password. Moving to the bookmark information, a representative example of a bookmark entry 610 is illustrated as a single row of a table. It shall be appreciated that any number of bookmarks may be stored, but that only five have been illustrated to preserve clarity. Bookmark entry 610 includes an identifier 612 for use by gateway 30 and bookmark device 32 during communication. Identifier 612 may be numeric, alphanumeric, unique, or relative. Additionally, each bookmark entry 610 includes a date 614 and a time 616 representing the time when the user created the bookmark by activating the input control 212 of bookmark device 32. In an alternate form, bookmark device 32 may store a time or count and subsequently compute a time and date based upon the last sync with gateway 30 upon connection to gateway 30. Bookmark entry 610 also includes a user preference indicator 618, which may represent the level of interest of the user, such as on a scale of minus three to positive 3, or on a scale of one to ten. Other forms have user preference indicator 618 represent one of a number of user-defined or predefined categories. In a further form, each category may have two or more levels of user interest, such as positive or negative, very interested or slightly interested.

Turning to the bookmark transfer and content retrieval process, in the illustrative embodiment, system 20 of FIG. 1 includes at least two computers, namely gateway 30 and server 40. In one form gateway 30 is a personal computer such as a desktop or laptop computer. Gateway 30 may include wired connection ports such as universal serial bus (USB), IEEE 1394 (Firewire), or serial, and wireless connection hardware such as Bluetooth, 802.11, or infrared to name just a few non-limiting examples, suitable for connection to bookmarking device 32 and personal multimedia device 34. Additionally, server 40 is operable as a web-server to serve web pages to a number of computers, such as gateway 30, via computer network 22.

It shall be appreciated that server 40 may be a single server or a larger number of servers, such as a server farm, in order to adequately handle user demand. Preferably, server 40 includes both a primary and a backup server allocated to the tasks described herein to maintain a constant service level.

Specifically, computers 30 and 40 include one or more processors or CPUs (26a and 26b respectively) and one or more types of memory 28a and 28b, respectively). Each memory 28 preferably includes a removable memory device. Each processor 26 may be comprised of one or more components configured as a single unit. When of a multi-component form, a processor 26 may have one or more components located remotely relative to the others. One or more components of each processor 26 may be of the electronic variety defining digital circuitry, analog circuitry, or both. In one embodiment, each processor 26 is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer devices such as those illustrated in FIG. 1 may coupled together by computer network 22.

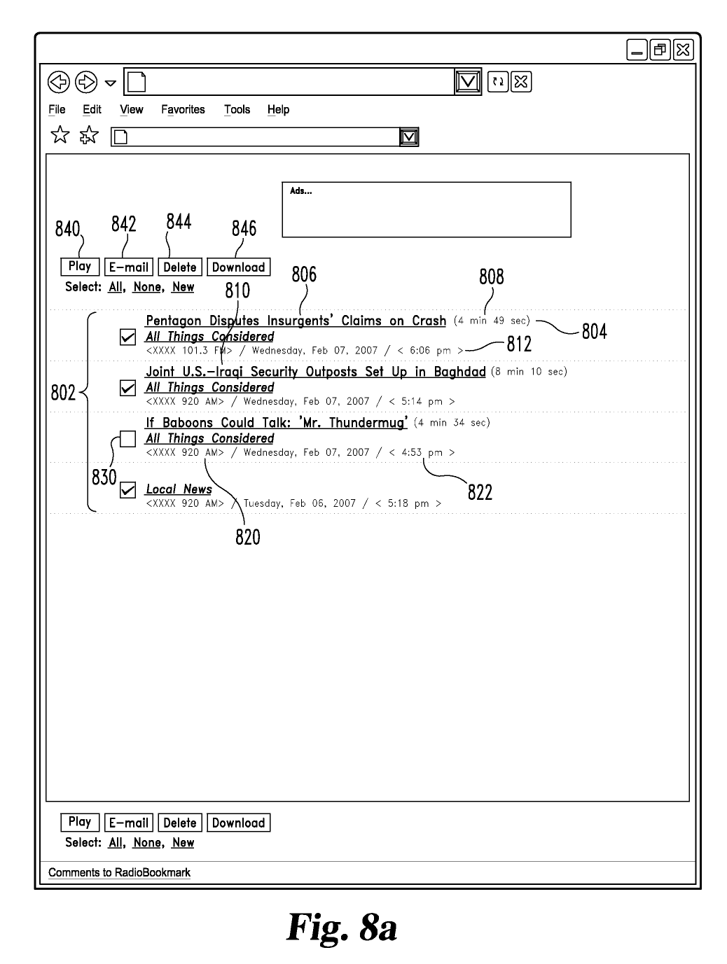

Turning to FIG. 7, with continued reference to FIG. 1, the process for bookmark creation and subsequent content retrieval according to one form of the present system and method is illustrated. The process begins at start point 702 with a user activating input control 212 on bookmark device 32 and storing a bookmark entry (stage 704). The bookmark device 32 is then operably connected to gateway 30 (stage 706). It shall be appreciated that one or more bookmark entries may be created prior to connection with gateway 30 by repeating step 704 any number of times. Once connected, the gateway 30 reads the bookmark entries from bookmark device 32 (stage 708). Once read, the gateway 30 connects to server 40. In one form, the gateway 30 transfers the serial number of bookmark device 32, which may be unique, in order to facilitate user log in or recognition. In another form, the user provides a username and password combination allowing the server 40 to remember users and their preferences. Once connected, gateway 30 transfers at least one bookmark entry to server 40 (stage 712). Preferably, server 40 stores the bookmark entries received for subsequent manipulation by the user. Server 40 then utilizes the bookmark entry received to search within content database 44 for a content segment having broadcast time information matching that of the bookmark entry (stage 714). In addition to the bookmark entry time information, server 40 may also utilize a broadcast station identifier in order to locate the content segment the user is seeking. Once located, server 40 performs a bookmark time correction process (stage 716), described in detail below, to ensure that the user bookmark time accurately reflects the content segment the user intended. The server 40 then presents the selected content segment and its associated information to the user, such as through gateway 30 (stage 718). The process ends at end point 720.

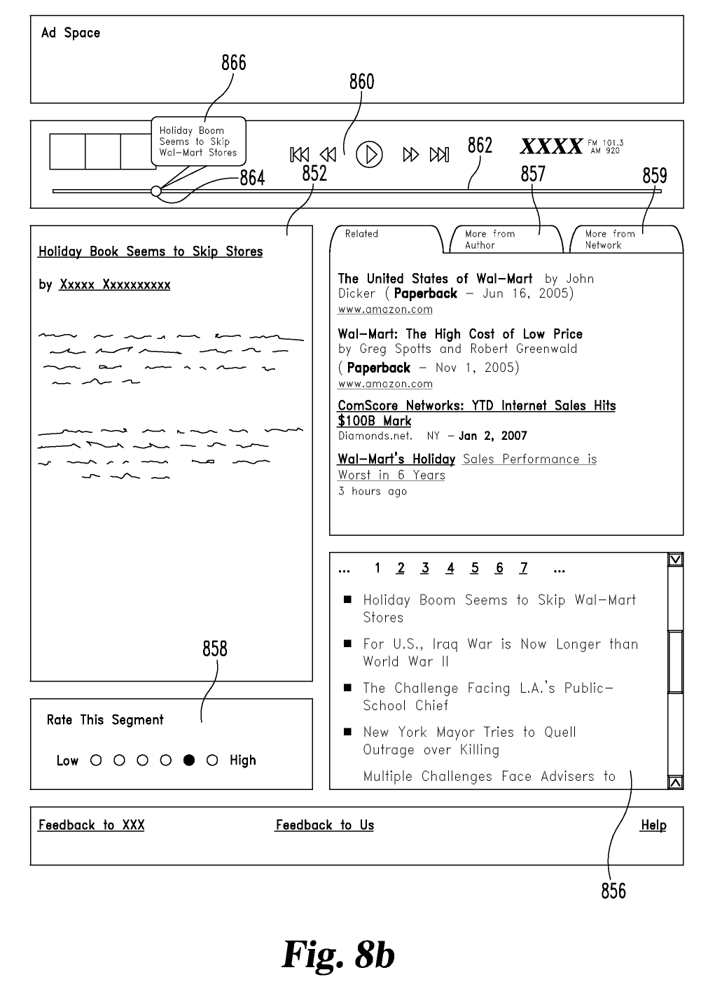

FIG. 8a illustrates a sample screenshot, such as for presentation on gateway 30, which is created by server 40 in response to transmission of a plurality of bookmark entries. The received bookmark entries are each represented by identified content segments listings 802. Turning to one illustrative example, content segment listing 804 has an associated segment title 806, run length 808, broadcast station 810, and broadcast time 812. In the event a content segment is not the one intended, the user may manipulate the current listing by activating the arrows adjacent to a listing, such as arrows 820 to select a different broadcast station or arrows 822 to select an earlier/later broadcast time. Additionally, the user may select a number of content segments listings 802 using associated checkboxes 830 and subsequently play, email, delete, or download a number of content segments using buttons 840, 842, 844, and 846 respectively. In the event a user desires more information, the user may select a specific content segment, such as segment 806, and be taken to a more detailed page, illustrated in FIG. 8b.

FIG. 8b illustrates a sample screenshot, such as for presentation on gateway 30, which is created by server 40 in response to the selection of a specific content segment listing. Central section 852 displays the detailed information concerning the content segment selected. In the information section 854, information relative to the identified content segment matching the currently selected content segment is presented. In a further form the information presented in central section 854 as well as other sections of the page may be periodically refreshed during the playback of a content segment to present information matching the current portion of the content segment, such as the current topic. For example, a user may be streaming a 30 minute talk show segment, currently in a portion describing increasing gasoline prices. At this point, the information presented in central section 854 may be a graph showing the trend in gas prices at the pump, or may include supplemental articles or other identified information. Additionally, a bookmark listing window 856 indicates the current bookmark which defines the content segments displayed in sections 852 and includes additional bookmark listings, similar to the main screen of FIG. 8a. Using windows 856, the user may easily navigate between the various bookmark entries provided and interact with the content segments. A user may also view their current rating of the content segment in portion 852, or if no rating is currently provided, the user may supply one using rating box 858. A playback section 860 is also provided which allows a user to playback the current segment and control its playback. In addition, playback progress indicator 864 moves along a timeline 862 showing the progress of the playback. In addition, a pop-up, such as window 866, may identify the current topic of the broadcast segment or otherwise. Additional tabs, such as tab 857 and 859 may provide additional information panes such as more content from the same author or more content from the same broadcast provider respectively.

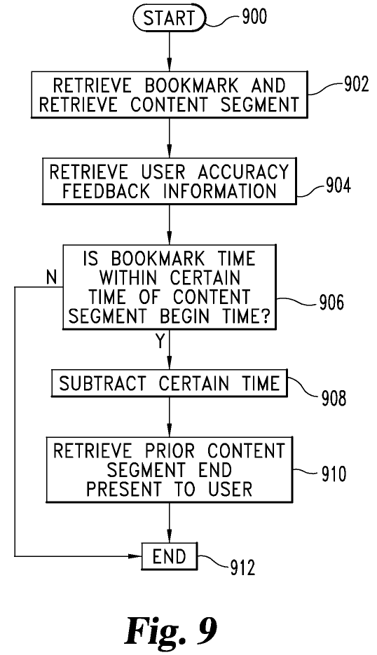

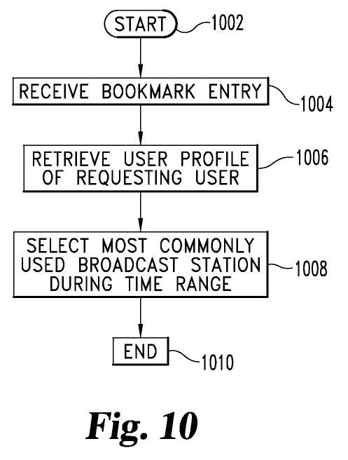

Turning to FIG. 9 the steps making up one form of the process for correcting bookmark time information is illustrated. In one form, where the content segments marked by a user are relatively short in length, such as music or songs, and the likelihood of a bookmark being created shortly after a content segment ends is elevated. The process begins at start point 900 with the server 40 receiving bookmark time information and retrieving a corresponding content segment from content database 44 (stage 902). The server 40 then retrieves a history of user feedback (stage 904), such as the number of times a user has indicated that a content segment returned was incorrect, or the number of times a user has selected the previous section in FIG. 10, indicating an interest in the prior content segment. The server 40 then determines if the bookmark time is within a certain time of the beginning of a content segment (stage 906). If the user frequently selected a prior segment, then the time frame may be extended to allow for delayed bookmarking. If the server 40 identifies a bookmark which occurs very early in a content segment and within this time range, then the server 40 subtracts a certain time amount from the bookmark time to ensure it correctly falls within the broadcast time of the preceding content segment (stage 908). The server 40 then retrieves the preceding content segment and presents it to the user (stage 910). If the server 40 does not identify the bookmark time as within a certain time period of the beginning broadcast time and thus likely late, then no correction is needed and the process ends at end point 912.

FIG. 10 illustrates a process for intelligently associating a broadcast station for use with a bookmark entry based upon prior user selections. The process is useful in one form of the present system and method wherein multiple broadcast stations make content available via one or more content databases. The process begins at start point 1002 with the server 40 receiving a bookmark entry including time information (stage 1004). The server 40 then retrieves a user profile associated with the current user or bookmark device 32 (stage 1006). Using the profile, the server 40 selects the most commonly used broadcast station during a time range containing the time associated with the current bookmark entry (stage 1008). In one form, the time ranges may be one hour in length to capture a user's varying tendencies while in other forms the time ranges may be of different lengths to accommodate more established listening patterns. Once the most likely broadcast station is selected the process ends at end point 1010 and the server 40 queries content database 44 using the time provided by the bookmark entry and the broadcast station selected. If the user indicated that the broadcast station is incorrect then the server 40 takes that information and modifies the current time range in the user profile to increment the user specified broadcast station.

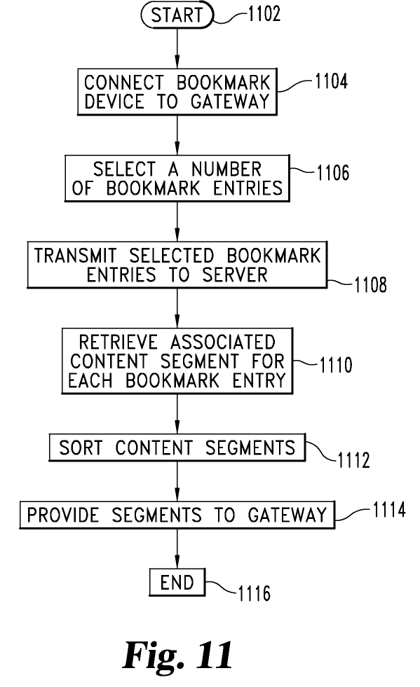

Turning to FIG. 11, with continued reference to FIG. 1, the process for bookmark creation and bulk content retrieval according to another form of the present system and method is illustrated. In addition to the user interface provided in FIG. 8, a quick bulk download process may be desired by a user simply wishing to retrieves a larger number of content segments in one batch process all having the same or a known broadcast station. The process begins at start point 1102 with the user connecting device 32 to gateway 30 (stage 1104). The user then selects a number of bookmark entries using gateway 30 (stage 1106). Gateway 30 transmits the selected batch of bookmark entries to server 40 (stage 1108). Server 40 then retrieves a segment of content corresponding to each bookmark entry based upon time information (stage 1110). Optionally, the server 40 may sort the content segments based upon their respective user preference indicators (stage 1112). The server 40 then provides the selected content segments in bulk to gateway 30 (stage 1114) for subsequent listening or download, such as to personal multimedia device 34. In one form, the bookmark entries may include a user preference indicator and the content segments may be transferred in interest level order having the most interesting segments downloaded first. In an alternate form, the server 40 may provide an audio stream of the content segments selected and allow the user to easily navigate from the start of one segment to the other. Again, the content segments may be ordered according to their associated user preference indicator based upon interest level or categorization. Additionally, a user may send information corresponding to a content segment associated with a bookmark entry to another person or user, such as via e-mail, text message, instant message, or the like. The process ends at end point 1116.

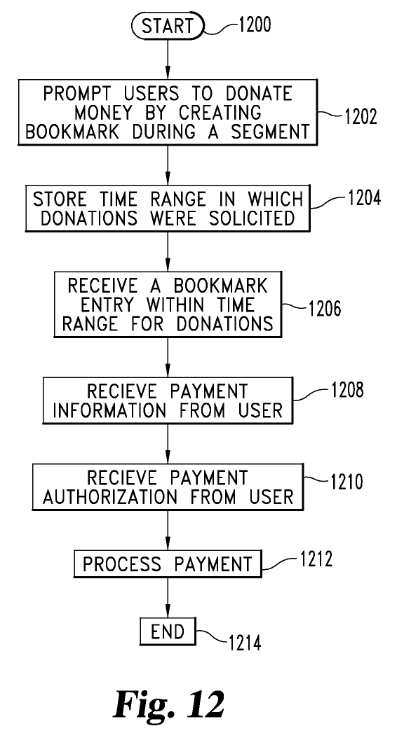

In an alternate form, the user bookmark device of system 20 may be utilized to accept user donations, such as in the case of a non-profit or user supported broadcast station. FIG. 12 illustrates the steps involved in prompting for and receiving a donation from a user in yet another form of the present system and method. The process begins at start point 1200 with the broadcast station 50 of FIG. 1 broadcasting a segment prompting the users to donate money to a cause, such as the broadcast station itself or some other entity by creating a bookmark during the segment (stage 1202). Next, the server 40 stores the time range during which donations were requested (stage 1204). In an alternate form, the server 40 may store a content segment in content database 44 having a donation requested flag. Upon connection of bookmark device 32 to gateway 30 by a user, server 40 receives a bookmark entry having an associated broadcast time which falls within the stored time range in which donations were requested (stage 1206). The server 40 then prompts the user for payment information (stage 1208), which may include credit card information, a mailing address for a check or money order, or account information for online payment processors such as PayPal®. In an alternate form, the user may provide payment information for storage prior to being prompted for a donation in stage 1202, in which case stage 1208 may be omitted. Once payment information is available to server 40, the user authorizes payment by sending an authorization to server 40 (step 1210). The authorization may include a payment amount, which may be determined as a function of the number of times the user activated input control 212, may be user entered, or may be a predetermined amount. Finally, the payment is processed (stage 1212) and the process ends at end point 1214.

In other embodiments, the user may configure server 40 to donate a predetermined amount from a predefined source, such as a credit card or bank account, periodically, based upon the number of bookmarks received associated with the user. For example, a user may wish to donate one dollar for every 10 bookmarks established. In a further form, the server 40 may only count bookmarks having a positive user preference indicator.

Further, it shall be appreciated that the user preference indication information provided with by bookmark device 32 may be highly useful to the broadcast station 50 and may be collected and analyzed by server 40 for purposes such as market analysis, audience profiling, content selection/recommendation, and determining user interest levels.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. An system for retrieving broadcast content comprising:
a portable bookmarking device including a least one input control, a memory module, and a communication interface, said input control operable to cause said bookmarking device to store in said memory module time information representing a broadcast time at which a segment was broadcast and a corresponding user preference indicator representing one of a plurality of selectable interest levels of the user in said segment;
a gateway operable to connect to said communication interface and receive said time information and said user preference indicator from said bookmarking device;
a content database for storing broadcast segments of content including a respective broadcast time and related information;
at least one server operable to receive said time information and said user preference information from said gateway and in response send information representing at least a first segment of content selected from said content database based upon said time information and said user preference indicator.

2. The system of claim 1, wherein said input control comprises a first selectable electronic button.

3. The system of claim 2, wherein said user preference indicator is a function of the number of times said button is consecutively activated by a user.

4. The system of claim 2, wherein said user preference indicator is a function of the length of time said button is activated by a user.

5. The system of claim 2, wherein said user preference indicator is a function of the pattern in which said button is activated by a user.

6. The system of claim 2, wherein said input control further comprises a second selectable electronic button.

7. The method of claim 6, wherein said first button is operable to store said user preference indicator as positive and said second button is operate to store said user preference indicator as negative.

8. The method of claim 7, wherein said first button and said second button are operable to store varying degrees of interest based upon the number of times consecutively activated by a user.

9. The method of claim 7, wherein said first button and said second button are operable to store varying degrees of interest based upon the length of time activated by a user.

10. The system of claim 1, wherein said portable bookmarking device further includes user information identifying the user of said portable bookmarking device within said memory module.

11. The system of claim 1, wherein said communication interface is a Universal Serial Bus interface.

12. The system of claim 1, wherein said communication interface is an infrared interface.

13. The system of claim 1, wherein said communication interface is an interface selected from the group consisting of Bluetooth, IEEE 1394, and IEEE 802.11.

14. The system of claim 1, wherein said memory module is non-volatile.

15. The system of claim 1, wherein said gateway is a personal computer.

16. The system of claim 1, wherein said server is further operable to transmit said first segment of content to said gateway.

17. The system of claim 16, wherein said first segment of content is an audio file.

18. The system of claim 16, wherein said first segment of content is streamed to said gateway.

19. The system of claim 1, wherein said plurality of selectable interest levels is at least 3.

20. The system of claim 6, wherein said input control further comprises a third selectable electronic button.

21. The system of claim 19, wherein said plurality of selectable interest levels is at least 5.

22. The system of claim 21, wherein said plurality of selectable interest levels is at least 9.

23. The system of claim 1, wherein said plurality of selectable interest levels are categories.

24. The system of claim 22, wherein said categories of subject matter are at least partially defined by a user.

25. The system of claim 22, wherein at least one of said categories of subject matter is divided into a plurality of qualitative interest levels.

26. The system of claim 1, wherein said server is further operable to transmit a plurality of segments of content selected from said content database based upon said time information and ranked based upon said user preference indicator.

27. The system of claim 23, wherein said server is further operable to transmit a plurality of segments of content selected from said content database based upon said time information and sorted based upon said user preference indicator.

28. A method for delivering personalized content comprising:
maintaining a content database containing broadcast segments and broadcast times at which respective segments are broadcast;
storing time information representing a plurality of broadcast times in a portable bookmarking device, each broadcast time representing a time at which a particular broadcast segment was broadcast;
transmitting said time information to a first server using a gateway;
locating a plurality of broadcast segments within said content database, each of said plurality of broadcast segments having a broadcast time matching one of said plurality of broadcast times within said time information received from said gateway; and
transmitting said plurality of broadcast segments to said gateway.

29. The method of claim 28, further comprising the step of:
transferring said plurality of broadcast segments from said gateway to a personal multimedia player.

30. The method of claim 29, wherein said personal multimedia player is a handheld MP3 player.

31. The method of claim 29, wherein said personal multimedia player is an audio enabled wireless telephone.

32. The method of claim 28, wherein a said plurality of broadcast segments correspond to a subset of said plurality of broadcast times in said portable bookmarking device.

33. The method of claim 32, wherein said plurality of broadcast segments are of the same category.

34. The method of claim 32, wherein said plurality of broadcast segments each has an associated user preference indicator about a predetermined threshold.

35. The method of claim 34, wherein said predetermined threshold is defined by the user.

36. The method of claim 28, further comprising the steps of:
recommending said plurality of broadcast segments to another user.

37. The method of claim 36, wherein said recommending includes sending a hyperlink.

38. The method of claim 37, wherein said hyperlink is sent in an e-mail.

39. The method of claim 28, further comprising the step of:
prompting the user to make a donation to the provider of a first content segment within said plurality of content.

40. A method for delivering personalized content comprising:
maintaining a content database containing broadcast segments and broadcast times at which respective segments are broadcast;
storing time information representing a plurality of broadcast times in a portable bookmarking device, each broadcast time representing a time at which a particular broadcast segment was broadcast;
transmitting said time information to a first server using a gateway;
locating a plurality of broadcast segments within said content database, each of said plurality of broadcast segments having a broadcast time matching one of said plurality of broadcast times within said time information received from said gateway; and
streaming a single audio file comprising said plurality of broadcast segments to said gateway.

41. The method of claim 40, further comprising the steps of:
receiving an indication to skip to a certain broadcast segment in said plurality of broadcast segments from said gateway; and
advancing said audio file to a point representing the start of said certain broadcast segment and continuing said streaming.

42. A method for suggesting content based upon user feedback comprising the steps of:
maintaining a content database containing broadcast segments and associated segment information including a broadcast time at which a respective segment was broadcast;
receiving time information representing a plurality of broadcast times at which a segment was broadcast and a corresponding user preference indicator representing one of a plurality of selectable interest levels of the user in said segment stored in a handheld bookmarking device;
locating a plurality of broadcast segments within said content database, each of said plurality of broadcast segments having a broadcast time matching one of said plurality of broadcast times within said time information received from said gateway;
determining a user profile as a function of said segment information associated with said plurality of broadcast segments;
selecting at least one broadcast segments based upon said user profile; and
presenting said broadcast segment to the user.

43. The method of claim 42, wherein said segment information includes keywords.

44. The method of claim 42, wherein said segment information contains at least one topical category.

45. A method for presenting content based upon user feedback comprising:
receiving a bookmark entry comprising time information representing a broadcast time at which a segment was broadcast from a handheld bookmarking device;
searching a content database comprising a plurality of radio content segments and associated broadcast time range information for a first content segment having an associated broadcast time range containing said broadcast time received;
determining that said broadcast time falls within a predetermined time period at the beginning of said broadcast time range; and
correcting said broadcast time received to be a time prior to said broadcast time range.

46. The method of claim 45, wherein said predetermined time period is calculated as a function of a user accuracy score reflecting prior bookmark entry accuracy feedback received from the user.

47. A method for determining a likely radio station comprising the steps of:
receiving log in information uniquely identifying a particular user from a gateway;
receiving a first plurality of bookmark entries comprising time information representing a broadcast time at which a segment was broadcast stored within a handheld bookmarking device connected to said gateway;
receiving a first plurality of radio broadcast station information from said gateway defining which radio station is associated with said first plurality of bookmark entries; and
determining a most probable radio station corresponding to a subsequently received bookmark entry based at least upon said first plurality of radio broadcast station information.

48. A method for receiving donations from a user comprising the steps of:
prompting a user to donate a sum of money to a specified entity during a broadcast segment by creating a bookmark entry during a first time range;
receiving a bookmark entry including a bookmark time from a user created using a bookmarking device;
determining that said bookmark time is within said first time range; and
receiving a monetary donation from the user in response to said determining.

49. The method of claim 48, wherein payment information associated with the user is received prior to said receiving a bookmark entry.

50. The method of claim 49, wherein said payment information includes a credit card number.

51. The method of claim 49, wherein said payment information includes online payment provider account information.

52. The method of claim 48, wherein said specific entity is the broadcaster of said broadcast segment.

53. The method of claim 48, wherein said broadcast segment is a radio segment.

54. The method of claim 48, wherein the amount of said monetary donation is a function of the number of times the user activates said bookmark device to create said bookmark entry.

55. A method for presenting information corresponding to a portion of a content segment comprising the steps of:
retrieving said content segment having an associated broadcast time from a content database using time information received from a gateway device;
determining a plurality of topics, corresponding to at least a first portion of said content segment;
retrieving a plurality of information segments, each information segment having a topic related to at least one of said plurality of topics; and
presenting said first portion of said content segment and said information segments to a user simultaneously using said gateway device.

56. The method of claim 55, wherein said time information is created using a bookmarking device and transmitted to said gateway device.

57. The method of claim 55, wherein said plurality of topics is a list of keywords.

58. The method of claim 55, wherein said plurality of information segments include news articles.

59. The method of claim 55, wherein said plurality of information segments include hyperlinks.

60. The method of claim 56, wherein said information segments are presented on a web page on said gateway device.
